(19) United States
(12) Patent Application Publication
(10) Pub. No.: US 2025/0190756 A1
(43) Pub. Date: Jun. 12, 2025

(54) System, Method, and Computer Program Product for Encoding Feature Interactions Based on Tabular Data Using Machine Learning

(71) Applicant: Visa International Service Association, San Francisco, CA (US)

(72) Inventors: Kaixiong Zhou, Houston, TX (US); Huiyuan Chen, San Jose, CA (US); Lan Wang, Sunnyvale, CA (US); Mangesh Bendre, Sunnyvale, CA (US); Fei Wang, Fremont, CA (US); Hao Yang, San Jose, CA (US)

(21) Appl. No.: 18/845,555

(22) PCT Filed: May 25, 2023
(86) PCT No.: PCT/US2023/023509

§ 371 Date: Sep. 10, 2024

Related U.S. Application Data
(60) Provisional application No. 63/345,599, filed on May 25, 2022.

(51) Int. Cl. G06N 3/045; G06F 7/78; G06Q 20/40

(52) U.S. Cl. CPC G06N 3/045; G06F 7/78; G06Q 20/4016

(57) ABSTRACT

Methods, systems, and computer program products are provided for encoding feature interactions based on tabular data. An exemplary method includes receiving a dataset in a tabular format including a plurality of rows and a plurality of columns. Each column is indexed to generate a position embedding matrix. Each column is grouped based on at least one tree model to generate a domain embedding matrix. An input vector is generated based on the dataset, the position embedding matrix, and the domain embedding matrix. The input vector is inputted into a first multilayer perceptron (MLP) model to generate a first output vector, which is transposed to generate a transposed vector. The transposed vector is inputted into a second MLP model to generate a second output vector, which is inputted into at least one classifier model to generate at least one prediction.

### CROSS-REFERENCE TO RELATED APPLICATIONS

This application is the United States national Phase of International Patent Application No. PCT/US23/23509 filed on May 25, 2023, and claims priority to U.S. Provisional Patent Application No. 63/345,599, filed on May 25, 2022, the disclosures of which are hereby incorporated by reference in their entireties.

### BACKGROUND

### 1. Technical Field

This disclosure relates generally to encoding features using machine learning models and, in some non-limiting embodiments or aspects, to systems, methods, and computer program products for encoding feature interactions based on tabular data and machine learning models.

### 2. Technical Considerations

Tabular data (e.g., tables, data tables, tabular data sets, and/or the like) may include an arrangement of data (e.g., information) in rows and/or columns including elements (e.g., values). Rows of tabular data may be ordered or unordered. Columns of tabular data may include an identification, such as a name of a field (e.g., parameter, feature, and/or the like) which may apply to each element of a column.

Tabular data may be used in the analysis of data with machine learning techniques. Some systems may use machine learning models to learn tabular data due to the structure and organization of the data in a tabular format. For example, deep learning models, such as deep neural networks (DNNs), may be trained with tabular data in order to learn features and make predictions.

However, systems using machine learning become difficult to scale to analyze tabular data including millions of data instances with thousands of features. The number of data instances and features in the data tables may cause a computational bottleneck when the entire set of tabular data is stored in memory of a computing device. Additionally, deep learning models used to learn features in tabular data may not be scaled to large tabular data sets and may result in poor performance. In some instances, systems with poor performance may not be sufficient for training machine learning models on the fly and/or for meeting the requirements of online services, such as latency or memory requirements.

### SUMMARY

Accordingly, provided are improved systems, methods, and computer program products for encoding feature interactions based on tabular data and machine learning that overcome some or all of the deficiencies identified above.

According to non-limiting embodiments or aspects, provided is a computer-implemented method for encoding feature interactions based on tabular data. In some non-limiting embodiments or aspects, the computer-implemented method may include receiving a dataset in a tabular format including a plurality of rows and a plurality of columns. Each row of the plurality of rows may represent a respective data instance of a plurality of data instances. Each column of the plurality of columns may represent a respective feature of a plurality of features. Each data instance of the plurality of data instances may include a plurality of values including a respective value associated with each respective feature of the plurality of features. The computer-implemented method further may include indexing each column of the plurality of columns to generate a position embedding matrix including a plurality of position embedding vectors. Each position embedding matrix row of the position embedding matrix may include a respective position embedding vector of the plurality of position embedding vectors associated with the respective column of the plurality of columns. The computer-implemented method further may include grouping each column of the plurality of columns based on at least one tree model to generate a domain embedding matrix including a plurality of domain embedding vectors. The computer-implemented method further may include generating an input vector based on the dataset, the position embedding matrix, and the domain embedding matrix. The computer-implemented method further may include inputting the input vector into a first multilayer perceptron (MLP) model to generate a first output vector. The computer-implemented method further may include transposing the first output vector to generate a transposed vector. The computer-implemented method further may include inputting the transposed vector into a second MLP model to generate a second output vector. The computer-implemented method further may include inputting the second output vector into at least one classifier model to generate at least one prediction.

In some non-limiting embodiments or aspects, the at least one prediction may include at least one predicted label.

In some non-limiting embodiments or aspects, the plurality of data instances may include a plurality of payment transaction records. In some non-limiting embodiments or aspects, the at least one predicted label may indicate that a respective payment transaction record of the plurality of payment transaction records is predicted to be fraudulent.

In some non-limiting embodiments or aspects, generating the input vector may include concatenating at least one row of the dataset, at least one position embedding vector of the position embedding matrix, and at least one domain embedding vector of the domain embedding matrix to produce the input vector.

In some non-limiting embodiments or aspects, the computer-implemented method further may include embedding each value of the plurality of values to generate a dense embedding matrix. Each respective dense embedding matrix row of the dense embedding matrix may include a low-dimensional representation of the respective value.

In some non-limiting embodiments or aspects, generating the input vector may include generating the input vector based on the dense embedding matrix, the position embedding matrix, and the domain embedding matrix.

In some non-limiting embodiments or aspects, generating the input vector may include concatenating at least one row of the dense embedding matrix, at least one position embedding vector of the position embedding matrix, and at least one domain embedding vector of the domain embedding matrix to produce the input vector.

In some non-limiting embodiments or aspects, each value of the plurality of values may include one of a discrete value or a continuous value. In some non-limiting embodiments or aspects, embedding each discrete value may include encoding the discrete value with an independent embedding. In some non-limiting embodiments or aspects, embedding each continuous value may include encoding the continuous value based on scaling the continuous value with a shared embedding.

In some non-limiting embodiments or aspects, the computer-implemented method further may include modifying the input vector by replacing one or more values of the input vector to produce a modified input vector. The computer-implemented method further may include inputting the modified input vector into the first MLP model to generate a first modified output vector. The computer-implemented method further may include transposing the first modified output vector to generate a modified transposed vector. The computer-implemented method further may include inputting the modified transposed vector into the second MLP model to generate a second modified output vector. The computer-implemented method further may include adjusting parameters of at least one of the first MLP model, the second MLP model, or any combination thereof based on at least one of the first modified output vector, the second modified output vector, the modified input vector, or any combination thereof.

In some non-limiting embodiments or aspects, the computer-implemented method further may include normalizing the input vector based on layer normalization to generate a normalized input vector. In some non-limiting embodiments or aspects, inputting the input vector into the first MLP model may include inputting the normalized input vector into the first MLP model.

In some non-limiting embodiments or aspects, grouping each column based on at least one tree model to generate the domain embedding matrix may include grouping each column based on gradient-boosted decision trees.

According to non-limiting embodiments or aspects, provided is a system for encoding feature interactions based on tabular data. In some non-limiting embodiments or aspects, the system may include at least one processor and at least one non-transitory computer-readable medium storing instructions that, when executed by the at least one processor, cause the at least one processor to receive a dataset in a tabular format including a plurality of rows and a plurality of columns. Each row of the plurality of rows may represent a respective data instance of a plurality of data instances. Each column of the plurality of columns may represent a respective feature of a plurality of features. Each data instance of the plurality of data instances may include a plurality of values including a respective value associated with each respective feature of the plurality of features. Each column of the plurality of columns may be indexed to generate a position embedding matrix including a plurality of position embedding vectors. Each position embedding matrix row of the position embedding matrix may include a respective position embedding vector of the plurality of position embedding vectors associated with the respective column of the plurality of columns. Each column of the plurality of columns may be grouped based on at least one tree model to generate a domain embedding matrix including a plurality of domain embedding vectors. An input vector may be generated based on the dataset, the position embedding matrix, and the domain embedding matrix. The input vector may be input into a first MLP model to generate a first output vector. The first output vector may be transposed to generate a transposed vector. The transposed vector may be inputted into a second MLP model to generate a second output vector. The second output vector may be inputted into at least one classifier model to generate at least one prediction.

In some non-limiting embodiments or aspects, the at least one prediction may include at least one predicted label.

In some non-limiting embodiments or aspects, the plurality of data instances may include a plurality of payment transaction records. In some non-limiting embodiments or aspects, the at least one predicted label may indicate that a respective payment transaction record of the plurality of payment transaction records is predicted to be fraudulent.

In some non-limiting embodiments or aspects, generating the input vector may include concatenating at least one row of the dataset, at least one position embedding vector of the position embedding matrix, and at least one domain embedding vector of the domain embedding matrix to produce the input vector.

In some non-limiting embodiments or aspects, each value of the plurality of values may be embedded to generate a dense embedding matrix. Each respective dense embedding matrix row of the dense embedding matrix may include a low-dimensional representation of the respective value.

In some non-limiting embodiments or aspects, generating the input vector may include generating the input vector based on the dense embedding matrix, the position embedding matrix, and the domain embedding matrix.

In some non-limiting embodiments or aspects, generating the input vector may include concatenating at least one row of the dense embedding matrix, at least one position embedding vector of the position embedding matrix, and at least one domain embedding vector of the domain embedding matrix to produce the input vector.

In some non-limiting embodiments or aspects, each value of the plurality of values may include one of a discrete value or a continuous value. In some non-limiting embodiments or aspects, embedding each discrete value may include encoding the discrete value with an independent embedding. In some non-limiting embodiments or aspects, embedding each continuous value may include encoding the continuous value based on scaling the continuous value with a shared embedding.

In some non-limiting embodiments or aspects, the input vector may be modified by replacing one or more values of the input vector to produce a modified input vector. The modified input vector may be inputted into the first MLP model to generate a first modified output vector. The first modified output vector may be transposed to generate a modified transposed vector. The modified transposed vector may be inputted into the second MLP model to generate a second modified output vector. Parameters of at least one of the first MLP model, the second MLP model, or any combination thereof may be adjusted based on at least one of the first modified output vector, the second modified output vector, the modified input vector, or any combination thereof.

In some non-limiting embodiments or aspects, the input vector may be normalized based on layer normalization to generate a normalized input vector. In some non-limiting embodiments or aspects, inputting the input vector into the first MLP model may include inputting the normalized input vector into the first MLP model.

In some non-limiting embodiments or aspects, grouping each column based on at least one tree model to generate the domain embedding matrix may include grouping each column based on gradient-boosted decision trees.

According to non-limiting embodiments or aspects, provided is a computer program product for encoding feature interactions based on tabular data. In some non-limiting embodiments or aspects, the computer program product includes at least one non-transitory computer-readable medium including program instructions that, when executed by at least one processor, cause the at least one processor to receive a dataset in a tabular format including a plurality of rows and a plurality of columns. Each row of the plurality of rows may represent a respective data instance of a plurality of data instances. Each column of the plurality of columns may represent a respective feature of a plurality of features. Each data instance of the plurality of data instances may include a plurality of values including a respective value associated with each respective feature of the plurality of features. Each column of the plurality of columns may be indexed to generate a position embedding matrix including a plurality of position embedding vectors. Each position embedding matrix row of the position embedding matrix may include a respective position embedding vector of the plurality of position embedding vectors associated with the respective column of the plurality of columns. Each column of the plurality of columns may be grouped based on at least one tree model to generate a domain embedding matrix including a plurality of domain embedding vectors. An input vector may be generated based on the dataset, the position embedding matrix, and the domain embedding matrix. The input vector may be input into a first MLP model to generate a first output vector. The first output vector may be transposed to generate a transposed vector. The transposed vector may be inputted into a second MLP model to generate a second output vector. The second output vector may be inputted into at least one classifier model to generate at least one prediction.

In some non-limiting embodiments or aspects, the at least one prediction may include at least one predicted label.

In some non-limiting embodiments or aspects, the plurality of data instances may include a plurality of payment transaction records. In some non-limiting embodiments or aspects, the at least one predicted label may indicate that a respective payment transaction record of the plurality of payment transaction records is predicted to be fraudulent.

In some non-limiting embodiments or aspects, generating the input vector may include concatenating at least one row of the dataset, at least one position embedding vector of the position embedding matrix, and at least one domain embedding vector of the domain embedding matrix to produce the input vector.

In some non-limiting embodiments or aspects, each value of the plurality of values may be embedded to generate a dense embedding matrix. Each respective dense embedding matrix row of the dense embedding matrix may include a low-dimensional representation of the respective value.

In some non-limiting embodiments or aspects, generating the input vector may include generating the input vector based on the dense embedding matrix, the position embedding matrix, and the domain embedding matrix.

In some non-limiting embodiments or aspects, generating the input vector may include concatenating at least one row of the dense embedding matrix, at least one position embedding vector of the position embedding matrix, and at least one domain embedding vector of the domain embedding matrix to produce the input vector.

In some non-limiting embodiments or aspects, each value of the plurality of values may include one of a discrete value or a continuous value. In some non-limiting embodiments or aspects, embedding each discrete value may include encoding the discrete value with an independent embedding. In some non-limiting embodiments or aspects, embedding each continuous value may include encoding the continuous value based on scaling the continuous value with a shared embedding.

In some non-limiting embodiments or aspects, the input vector may be modified by replacing one or more values of the input vector to produce a modified input vector. The modified input vector may be inputted into the first MLP model to generate a first modified output vector. The first modified output vector may be transposed to generate a modified transposed vector. The modified transposed vector may be inputted into the second MLP model to generate a second modified output vector. Parameters of at least one of the first MLP model, the second MLP model, or any combination thereof may be adjusted based on at least one of the first modified output vector, the second modified output vector, the modified input vector, or any combination thereof.

In some non-limiting embodiments or aspects, the input vector may be normalized based on layer normalization to generate a normalized input vector. In some non-limiting embodiments or aspects, inputting the input vector into the first MLP model may include inputting the normalized input vector into the first MLP model.

In some non-limiting embodiments or aspects, grouping each column based on at least one tree model to generate the domain embedding matrix may include grouping each column based on gradient-boosted decision trees.

According to non-limiting embodiments or aspects, provided is a system for encoding feature interactions based on tabular data. In some non-limiting embodiments or aspects, the system includes at least one processor and at least one non-transitory computer-readable medium storing instructions that, when executed by the at least one processor, cause the at least one processor to perform any of the methods described herein.

According to non-limiting embodiments or aspects, provided is a computer program product for encoding feature interactions based on tabular data. In some non-limiting embodiments or aspects, the computer program product includes at least one non-transitory computer-readable medium including program instructions that, when executed by at least one processor, cause the at least one processor to perform any of the methods described herein.

Other non-limiting embodiments or aspects will be set forth in the following numbered clauses:
Clause 1: A computer-implemented method, comprising: receiving, with at least one processor, a dataset in a tabular format comprising a plurality of rows and a plurality of columns, wherein each row of the plurality of rows represents a respective data instance of a plurality of data instances, wherein each column of the plurality of columns represents a respective feature of a plurality of features, wherein each data instance of the plurality of data instances comprises a plurality of values comprising a respective value associated with each respective feature of the plurality of features; indexing, with at least one processor, each column of the plurality of columns to generate a position embedding matrix comprising a plurality of position embedding vectors, wherein each position embedding matrix row of the position embedding matrix comprises a respective position embedding vector of the plurality of position embedding vectors associated with the respective column of the plurality of columns; grouping, with at least one processor, each column of the plurality of columns based on at least one tree model to generate a domain embedding matrix comprising a plurality of domain embedding vectors; generating, with at least one processor, an input vector based on the dataset, the position embedding matrix, and the domain embedding matrix; inputting, with at least one processor, the input vector into a first multilayer perceptron (MLP) model to generate a first output vector; transposing, with at least one processor, the first output vector to generate a transposed vector; inputting, with at least one processor, the transposed vector into a second MLP model to generate a second output vector; and inputting, with at least one processor, the second output vector into at least one classifier model to generate at least one prediction.
Clause 2: The computer-implemented method of clause 1, wherein the at least one prediction comprises at least one predicted label.
Clause 3: The computer-implemented method of clauses 1 or 2, wherein the plurality of data instances comprises a plurality of payment transaction records, wherein the at least one predicted label indicates that a respective payment transaction record of the plurality of payment transaction records is predicted to be fraudulent.
Clause 4: The computer-implemented method of any of clauses 1-3, wherein generating the input vector comprises: concatenating at least one row of the dataset, at least one position embedding vector of the position embedding matrix, and at least one domain embedding vector of the domain embedding matrix to produce the input vector.
Clause 5: The computer-implemented method of any of clauses 1-4, further comprising: embedding, with at least one processor, each value of the plurality of values to generate a dense embedding matrix, each respective dense embedding matrix row of the dense embedding matrix comprising a low-dimensional representation of the respective value.
Clause 6: The computer-implemented method of any of clauses 1-5, wherein generating the input vector comprises generating the input vector based on the dense embedding matrix, the position embedding matrix, and the domain embedding matrix.
Clause 7: The computer-implemented method of any of clauses 1-6, wherein generating the input vector comprises: concatenating at least one row of the dense embedding matrix, at least one position embedding vector of the position embedding matrix, and at least one domain embedding vector of the domain embedding matrix to produce the input vector.
Clause 8: The computer-implemented method of any of clauses 1-7, wherein each value of the plurality of values comprises one of a discrete value or a continuous value, and wherein embedding each discrete value comprises encoding the discrete value with an independent embedding, and wherein embedding each continuous value comprises encoding the continuous value based on scaling the continuous value with a shared embedding.
Clause 9: The computer-implemented method of any of clauses 1-8, further comprising: modifying, with at least one processor, the input vector by replacing one or more values of the input vector to produce a modified input vector; inputting, with at least one processor, the modified input vector into the first MLP model to generate a first modified output vector; transposing, with at least one processor, the first modified output vector to generate a modified transposed vector; inputting, with at least one processor, the modified transposed vector into the second MLP model to generate a second modified output vector; and adjusting, with at least one processor, parameters of at least one of the first MLP model, the second MLP model, or any combination thereof based on at least one of the first modified output vector, the second modified output vector, the modified input vector, or any combination thereof.
Clause 10: The computer-implemented method of any of clauses 1-9, further comprising: normalizing, with at least one processor, the input vector based on layer normalization to generate a normalized input vector, wherein inputting the input vector into the first MLP model comprises inputting the normalized input vector into the first MLP model.
Clause 11: The computer-implemented method of any of clauses 1-10, wherein grouping each column based on at least one tree model to generate the domain embedding matrix comprises grouping each column based on gradient-boosted decision trees.
Clause 12: A system comprising: at least one processor; and at least one non-transitory computer-readable medium storing instructions that, when executed by the at least one processor, cause the at least one processor to: receive a dataset in a tabular format comprising a plurality of rows and a plurality of columns, wherein each row of the plurality of rows represents a respective data instance of a plurality of data instances, wherein each column of the plurality of columns represents a respective feature of a plurality of features, wherein each data instance of the plurality of data instances comprises a plurality of values comprising a respective value associated with each respective feature of the plurality of features; index each column of the plurality of columns to generate a position embedding matrix comprising a plurality of position embedding vectors, wherein each position embedding matrix row of the position embedding matrix comprises a respective position embedding vector of the plurality of position embedding vectors associated with the respective column of the plurality of columns; group each column of the plurality of columns based on at least one tree model to generate a domain embedding matrix comprising a plurality of domain embedding vectors; generate an input vector based on the dataset, the position embedding matrix, and the domain embedding matrix; input the input vector into a first multilayer perceptron (MLP) model to generate a first output vector; transpose the first output vector to generate a transposed vector; input the transposed vector into a second MLP model to generate a second output vector; and input the second output vector into at least one classifier model to generate at least one prediction.
Clause 13: The system of clause 12, wherein the at least one prediction comprises at least one predicted label, wherein the plurality of data instances comprises a plurality of payment transaction records, and wherein the at least one predicted label indicates that a respective payment transaction record of the plurality of payment transaction records is predicted to be fraudulent.
Clause 14: The system of clause 12 or clause 13, wherein generating the input vector comprises: concatenating at least one row of the dataset, at least one position embedding vector of the position embedding matrix, and at least one domain embedding vector of the domain embedding matrix to produce the input vector.
Clause 15: The system of any of clauses 12-14, wherein the instructions, when executed by the at least one processor, further cause the at least one processor to: embed each value of the plurality of values to generate a dense embedding matrix, each respective dense embedding matrix row of the dense embedding matrix comprising a low-dimensional representation of the respective value, wherein generating the input vector comprises generating the input vector based on the dense embedding matrix, the position embedding matrix, and the domain embedding matrix.
Clause 16: The system of any of clauses 12-15, wherein generating the input vector comprises: concatenating at least one row of the dense embedding matrix, at least one position embedding vector of the position embedding matrix, and at least one domain embedding vector of the domain embedding matrix to produce the input vector.
Clause 17: The system of any of clauses 12-16, wherein each value of the plurality of values comprises one of a discrete value or a continuous value, and wherein embedding each discrete value comprises encoding the discrete value with an independent embedding, and wherein embedding each continuous value comprises encoding the continuous value based on scaling the continuous value with a shared embedding.
Clause 18: The system of any of clauses 12-17, wherein the instructions, when executed by the at least one processor, further cause the at least one processor to: modify the input vector by replacing one or more values of the input vector to produce a modified input vector; input the modified input vector into the first MLP model to generate a first modified output vector; transpose the first modified output vector to generate a modified transposed vector; input the modified transposed vector into the second MLP model to generate a second modified output vector; and adjust parameters of at least one of the first MLP model, the second MLP model, or any combination thereof based on at least one of the first modified output vector, the second modified output vector, the modified input vector, or any combination thereof.
Clause 19: The system of any of clauses 12-18, wherein grouping each column based on at least one tree model to generate the domain embedding matrix comprises grouping each column based on gradient-boosted decision trees.
Clause 20: A computer program product comprising at least one non-transitory computer-readable medium including program instructions that, when executed by at least one processor, cause the at least one processor to: receive a dataset in a tabular format comprising a plurality of rows and a plurality of columns, wherein each row of the plurality of rows represents a respective data instance of a plurality of data instances, wherein each column of the plurality of columns represents a respective feature of a plurality of features, wherein each data instance of the plurality of data instances comprises a plurality of values comprising a respective value associated with each respective feature of the plurality of features; index each column of the plurality of columns to generate a position embedding matrix comprising a plurality of position embedding vectors, wherein each position embedding matrix row of the position embedding matrix comprises a respective position embedding vector of the plurality of position embedding vectors associated with the respective column of the plurality of columns; group each column of the plurality of columns based on at least one tree model to generate a domain embedding matrix comprising a plurality of domain embedding vectors; generate an input vector based on the dataset, the position embedding matrix, and the domain embedding matrix; input the input vector into a first multilayer perceptron (MLP) model to generate a first output vector; transpose the first output vector to generate a transposed vector; input the transposed vector into a second MLP model to generate a second output vector; and input the second output vector into at least one classifier model to generate at least one prediction.
Clause 21: A system comprising: at least one processor; and at least one non-transitory computer-readable medium storing instructions that, when executed by the at least one processor, cause the at least one processor to perform the method of any one of clauses 1-11.
Clause 22: A computer program product comprising at least one non-transitory computer-readable medium including program instructions that, when executed by at least one processor, cause the at least one processor to perform the method of any one of clauses 1-11.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for encoding feature interactions based on tabular data and machine learning according to some non-limiting embodiments or aspects;

FIG. 2 is a flow diagram for a method for encoding feature interactions based on tabular data and machine learning according to some non-limiting embodiments or aspects;

FIG. 3 is a diagram of an exemplary environment in which methods, systems, and/or computer program products, described herein, may be implemented according to some non-limiting embodiments or aspects;

FIG. 4 is a schematic diagram of example components of one or more devices of FIG. 1 and/or FIG. 3 according to some non-limiting embodiments or aspects; and

FIG. 5 is a schematic diagram of an implementation of systems and methods for encoding feature interactions based on tabular data and machine learning according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), payment tokens, or other identifiers associated with a customer account. The term “payment token” may refer to an identifier that is used as a substitute or replacement identifier for an original account identifier, such as a PAN. Account identifiers may be alphanumeric or any combination of characters and/or symbols. Payment tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of payment tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for encoding feature interactions, including, but not limited to, encoding feature interactions based on tabular data and machine learning. For example, non-limiting embodiments or aspects of the disclosed subject matter provide receiving a dataset in a tabular format including a plurality of rows and a plurality of columns. Each row of the plurality of rows may represent a respective data instance of a plurality of data instances. Each column of the plurality of columns may represent a respective feature of a plurality of features. Each data instance of the plurality of data instances may include a plurality of values including a respective value associated with each respective feature of the plurality of features. Each column of the plurality of columns may be indexed to generate a position embedding matrix including a plurality of position embedding vectors. Each position embedding matrix row of the position embedding matrix may include a respective position embedding vector of the plurality of position embedding vectors associated with the respective column of the plurality of columns. Each column of the plurality of columns may be grouped based on at least one tree model to generate a domain embedding matrix including a plurality of domain embedding vectors. An input vector may be generated based on the dataset, the position embedding matrix, and the domain embedding matrix. The input vector may be input into a first multilayer perceptron (MLP) model to generate a first output vector. The first output vector may be transposed to generate a transposed vector. The transposed vector may be input into a second MLP model to generate a second output vector. The second output vector may be input into at least one classifier model to generate at least one prediction. Such embodiments or aspects provide methods and systems that encode feature interactions based on tabular data which achieve improved performance and efficiency. Non-limiting embodiments or aspects may allow for scaling a system to analyze tabular data including millions of data instances with thousands of features while maintaining or improving performance (e.g., accuracy) and greatly improving efficiency. Additionally, non-limiting embodiments or aspects may reduce memory usage and computational bottleneck when a large (e.g., millions of data instances) set of tabular data is used as input to a machine learning model (e.g., used as training input and/or runtime input). Further, non-limiting embodiments used to learn features in tabular data may be scaled to large tabular data sets without sacrificing performance. Non-limiting embodiments or aspects may allow for training machine learning models on the fly and ignoring explicit computation of a similarity between a pair of features. Such non-limiting embodiments or aspects may improve the ability of a machine learning model to generalize feature interactions and classifications tasks with improved efficiency.

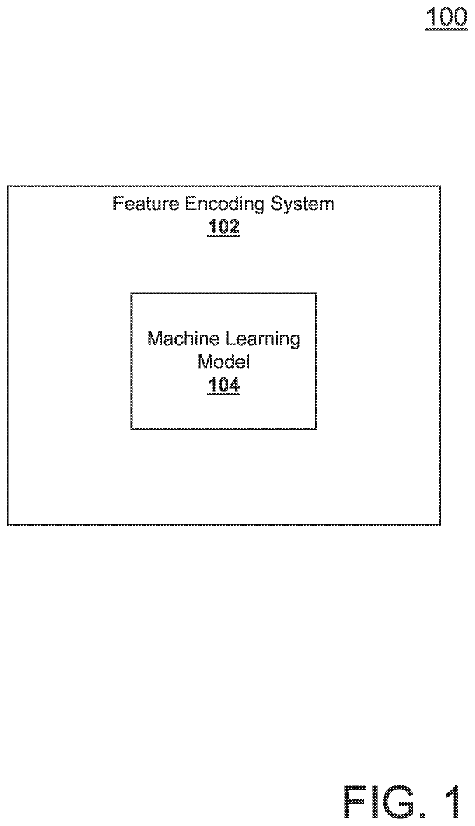

FIG. 1 depicts a system 100 for encoding feature interactions based on tabular data according to some non-limiting embodiments or aspects. The system 100 may include feature encoding system 102 and machine learning model 104.

Feature encoding system 102 may include a computing device, such as a server (e.g., a single server), a group of servers, and/or other like devices. In some non-limiting embodiments or aspects, feature encoding system 102 may include at least one processor (e.g., a multi-core processor) such as a graphics processing unit (GPU), a central processing unit (CPU), an accelerated processing unit (APU), a microprocessor, and/or the like. In some non-limiting embodiments or aspects, feature encoding system 102 may include memory, one or more storage components, one or more input components, one or more output components, and one or more communication interfaces, as described herein.

Machine learning model 104 may include one more machine learning models. For example, machine learning model 104 may include one or more convolutional neural networks (CNNs), feedforward artificial neural networks (ANNs), such as multilayer perceptrons (MLPs), deep neural networks (DNNs), decision trees (e.g., gradient-boosted decision trees), and/or the like. In some non-limiting embodiments or aspects, machine learning model 104 may be trained based on techniques described herein. In some non-limiting embodiments or aspects, machine learning model 104 may be used to generate a prediction as described herein. In some non-limiting embodiments or aspects, machine learning model 104 may be in communication with feature encoding system 102. In some non-limiting embodiments or aspects, machine learning model 104 may be implemented by (e.g., part of) feature encoding system 102. In some non-limiting embodiments or aspects, machine learning model 104 may be implemented by (e.g., part of) another system, another device, another group of systems, or another group of devices, separate from or including feature encoding system 102.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

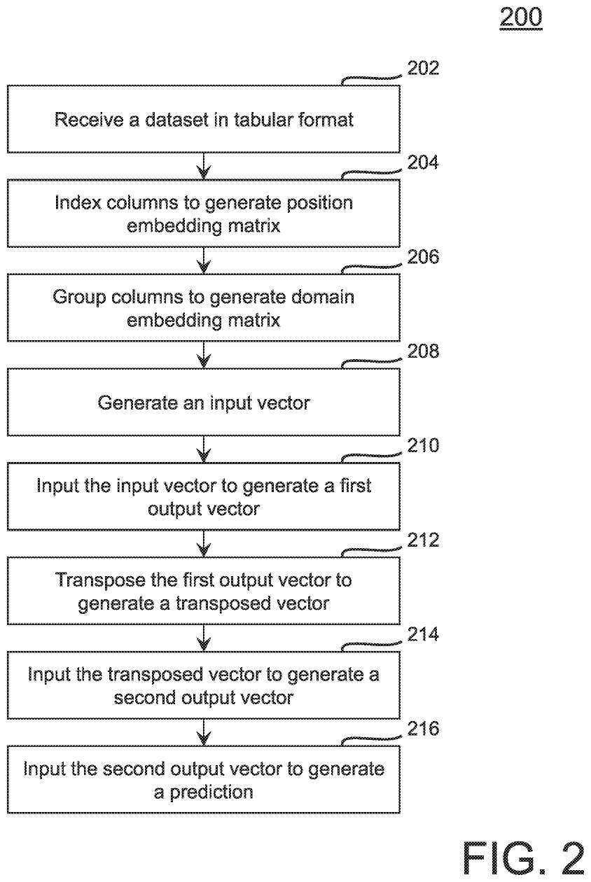

Referring now to FIG. 2, shown is a process 200 for encoding feature interactions based on tabular data according to some non-limiting embodiments or aspects. The steps shown in FIG. 2 are for example purposes only. It will be appreciated that additional, fewer, different, and/or a different order of steps may be used in non-limiting embodiments or aspects.

As shown in FIG. 2, at step 202, process 200 may include receiving a dataset in a tabular format. For example, feature encoding system 102 may receive a dataset in a tabular format including a plurality of rows and a plurality of columns. In some non-limiting embodiments or aspects, each row of the plurality of rows may represent a respective data instance of a plurality of data instances. In some non-limiting embodiments or aspects, each column of the plurality of columns may represent a respective feature of a plurality of features. In some non-limiting embodiments or aspects, each data instance of the plurality of data instances may include a plurality of values including a respective value associated with each respective feature of the plurality of features. In some non-limiting embodiments or aspects, the plurality of data instances may include a plurality of payment transaction records.

In some non-limiting embodiments or aspects, feature encoding system 102 may embed each value of the plurality of values to generate a dense embedding matrix. In some non-limiting embodiments or aspects, each respective dense embedding matrix row of the dense embedding matrix may include a low-dimensional representation of the respective value.

In some non-limiting embodiments or aspects, each value of the plurality of values may include one of a discrete value or a continuous value. In some non-limiting embodiments or aspects, feature encoding system 102 may embed each discrete value by encoding the discrete value with an independent embedding. In some non-limiting embodiments or aspects, feature encoding system 102 may embed each continuous value by encoding the continuous value based on scaling the continuous value with a shared embedding.

As shown in FIG. 2, at step 204, process 200 may include indexing columns to generate a position embedding matrix. For example, feature encoding system 102 may index each column of the plurality of columns to generate a position embedding matrix including a plurality of position embedding vectors. In some non-limiting embodiments or aspects, each position embedding matrix row of the position embedding matrix may include a respective position embedding vector of the plurality of position embedding vectors associated with the respective column of the plurality of columns.

As shown in FIG. 2, at step 206, process 200 may include grouping columns to generate a domain embedding matrix. For example, feature encoding system 102 may group each column of the plurality of columns based on at least one tree model to generate a domain embedding matrix including a plurality of domain embedding vectors. In some non-limiting embodiments or aspects, feature encoding system 102 may group each column of the plurality of columns based on gradient-boosted decision trees (e.g., XGBoost and/or the like).

As shown in FIG. 2, at step 208, process 200 may include generating an input vector. For example, feature encoding system 102 may generate an input vector based on the dataset, the position embedding matrix, and the domain embedding matrix. In some non-limiting embodiments or aspects, feature encoding system 102 may generate the input vector by concatenating at least one row of the dataset, at least one position embedding vector of the position embedding matrix, and at least one domain embedding vector of the domain embedding matrix to produce the input vector.

In some non-limiting embodiments or aspects, feature encoding system 102 may generate the input vector based on the dense embedding matrix, the position embedding matrix, and the domain embedding matrix. In some non-limiting embodiments or aspects, feature encoding system 102 may generate the input vector by concatenating at least one row of the dense embedding matrix, at least one position embedding vector of the position embedding matrix, and at least one domain embedding vector of the domain embedding matrix to produce the input vector.

In some non-limiting embodiments or aspects, feature encoding system 102 may modify the input vector. For example, feature encoding system 102 may modify the input vector by replacing one or more values (e.g., removing, replacing with a value of 0, replacing with a default value, and/or the like) of the input vector to produce a modified input vector. In some non-limiting embodiments or aspects, feature encoding system 102 may normalize the input vector. For example, feature encoding system 102 may normalize the input vector based on layer normalization to generate a normalized input vector.

As shown in FIG. 2, at step 210, process 200 may include inputting an input vector to generate a first output vector. For example, feature encoding system 102 may input the input vector to a first multilayer perceptron (MLP) model (e.g., machine learning model 104 thereof) to generate a first output vector. In some non-limiting embodiments or aspects, feature encoding system 102 may input the modified input vector to generate a first modified output vector. For example, feature encoding system 102 may input the modified input vector into the first MLP model to generate a first modified output vector. In some non-limiting embodiments or aspects, feature encoding system 102 may input the input vector into the first MLP model by inputting the normalized input vector into the first MLP model.

As shown in FIG. 2, at step 212, process 200 may include transposing a first output vector to generate a transposed vector. For example, feature encoding system 102 may transpose the first output vector to generate a transposed vector. In some non-limiting embodiments or aspects, feature encoding system 102 may transpose the first modified output vector to generate a modified transposed vector.

As shown in FIG. 2, at step 214, process 200 may include inputting a transposed vector to generate a second output vector. For example, feature encoding system 102 may input the transposed vector into a second MLP model (e.g., machine learning model 104 thereof) to generate a second output vector. In some non-limiting embodiments or aspects, feature encoding system 102 may input the modified transposed vector to generate a second modified output vector. For example, feature encoding system 102 may input the modified transposed vector into the second MLP model to generate a second modified output vector.

In some non-limiting embodiments or aspects, feature encoding system 102 may adjust parameters of an MLP model. For example, feature encoding system 102 may adjust parameters of at least one of the first MLP model, the second MLP model, or any combination thereof based on at least one of the first modified output vector, the second modified output vector, the modified input vector, or any combination thereof.

As shown in FIG. 2, at step 216, process 200 may include inputting a second output vector to generate a prediction. For example, feature encoding system 102 may input the second output vector into at least one classifier model (e.g., machine learning model 104 thereof) to generate at least one prediction. In some non-limiting embodiments or aspects, the at least one prediction may include at least one predicted label. In some non-limiting embodiments or aspects, the at least one predicted label may indicate that a respective payment transaction record of the plurality of payment transaction records is predicted to be fraudulent.

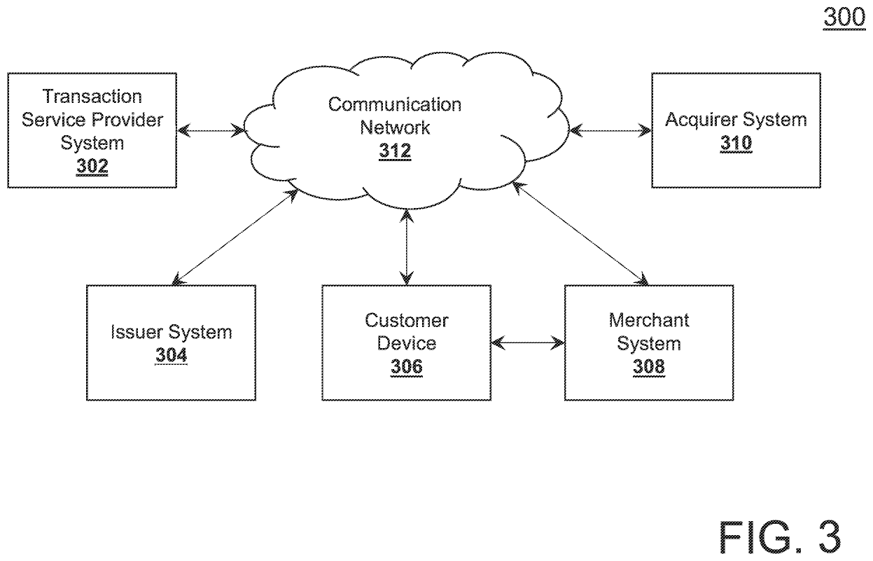

Referring now to FIG. 3, FIG. 3 is a diagram of a non-limiting embodiment or aspect of an exemplary environment 300 in which systems, products, and/or methods, as described herein, may be implemented. As shown in FIG. 3, environment 300 may include transaction service provider system 302, issuer system 304, customer device 306, merchant system 308, acquirer system 310, and communication network 312. In some non-limiting embodiments or aspects, each of feature encoding system 102 and/or machine learning model 104 may be implemented by (e.g., part of) transaction service provider system 302. In some non-limiting embodiments or aspects, at least one of each of feature encoding system 102 and/or machine learning model 104 may be implemented by (e.g., part of) another system, another device, another group of systems, or another group of devices, separate from or including transaction service provider system 302, such as issuer system 304, customer device 306, merchant system 308, acquirer system 310, and/or the like.

Transaction service provider system 302 may include one or more devices capable of receiving information from and/or communicating information to issuer system 304, customer device 306, merchant system 308, and/or acquirer system 310 via communication network 312. For example, transaction service provider system 302 may include a computing device, such as a server (e.g., a transaction processing server), a group of servers, and/or other like devices. In some non-limiting embodiments or aspects, transaction service provider system 302 may be associated with a transaction service provider as described herein. In some non-limiting embodiments or aspects, transaction service provider system 302 may be in communication with a data storage device, which may be local or remote to transaction service provider system 302. In some non-limiting embodiments or aspects, transaction service provider system 302 may be capable of receiving information from, storing information in, communicating information to, or searching information stored in the data storage device.

Issuer system 304 may include one or more devices capable of receiving information and/or communicating information to transaction service provider system 302, customer device 306, merchant system 308, and/or acquirer system 310 via communication network 312. For example, issuer system 304 may include a computing device, such as a server, a group of servers, and/or other like devices. In some non-limiting embodiments or aspects, issuer system 304 may be associated with an issuer institution as described herein. For example, issuer system 304 may be associated with an issuer institution that issued a credit account, debit account, credit card, debit card, and/or the like to a user associated with customer device 306.

Customer device 306 may include one or more devices capable of receiving information from and/or communicating information to transaction service provider system 302, issuer system 304, merchant system 308, and/or acquirer system 310 via communication network 312. Additionally or alternatively, each customer device 306 may include a device capable of receiving information from and/or communicating information to other customer devices 306 via communication network 312, another network (e.g., an ad hoc network, a local network, a private network, a virtual private network, and/or the like), and/or any other suitable communication technique. For example, customer device 306 may include a client device and/or the like. In some non-limiting embodiments or aspects, customer device 306 may or may not be capable of receiving information (e.g., from merchant system 308 or from another customer device 306) via a short-range wireless communication connection (e.g., an NFC communication connection, an RFID communication connection, a Bluetooth® communication connection, a Zigbee® communication connection, and/or the like), and/or communicating information (e.g., to merchant system 308) via a short-range wireless communication connection.

Merchant system 308 may include one or more devices capable of receiving information from and/or communicating information to transaction service provider system 302, issuer system 304, customer device 306, and/or acquirer system 310 via communication network 312. Merchant system 308 may also include a device capable of receiving information from customer device 306 via communication network 312, a communication connection (e.g., an NFC communication connection, an RFID communication connection, a Bluetooth® communication connection, a Zigbee® communication connection, and/or the like) with customer device 306, and/or the like, and/or communicating information to customer device 306 via communication network 312, the communication connection, and/or the like. In some non-limiting embodiments or aspects, merchant system 308 may include a computing device, such as a server, a group of servers, a client device, a group of client devices, and/or other like devices. In some non-limiting embodiments or aspects, merchant system 308 may be associated with a merchant as described herein. In some non-limiting embodiments or aspects, merchant system 308 may include one or more client devices. For example, merchant system 308 may include a client device that allows a merchant to communicate information to transaction service provider system 302. In some non-limiting embodiments or aspects, merchant system 308 may include one or more devices, such as computers, computer systems, and/or peripheral devices capable of being used by a merchant to conduct a transaction with a user. For example, merchant system 308 may include a POS device and/or a POS system.

Acquirer system 310 may include one or more devices capable of receiving information from and/or communicating information to transaction service provider system 302, issuer system 304, customer device 306, and/or merchant system 308 via communication network 312. For example, acquirer system 310 may include a computing device, a server, a group of servers, and/or the like. In some non-limiting embodiments or aspects, acquirer system 310 may be associated with an acquirer as described herein.

Communication network 312 may include one or more wired and/or wireless networks. For example, communication network 312 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 may be implemented within a single system or device, or a single system or device shown in FIG. 3 may be implemented as multiple, distributed systems or devices. Additionally or alternatively, a set of systems (e.g., one or more systems) or a set of devices (e.g., one or more devices) of environment 300 may perform one or more functions described as being performed by another set of systems or another set of devices of environment 300.

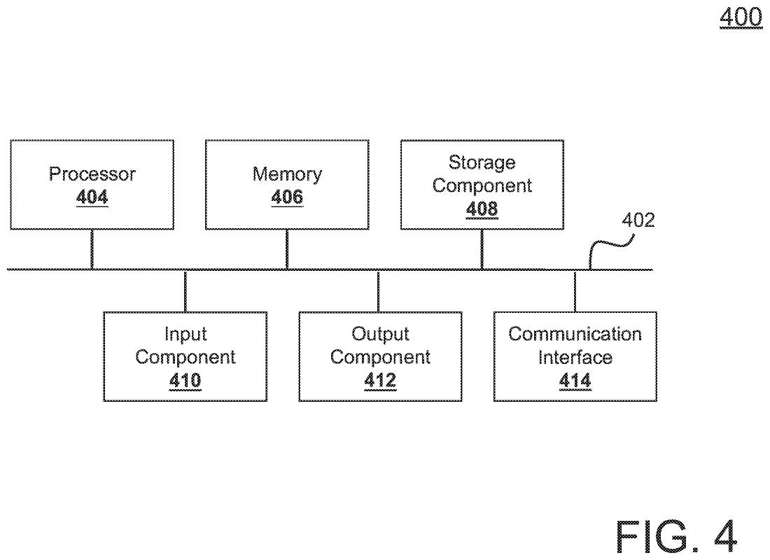

Referring now to FIG. 4, shown is a diagram of example components of a device 400 according to non-limiting embodiments or aspects. Device 400 may correspond to at least one of feature encoding system 102 and/or machine learning model 104 in FIG. 1 and/or at least one of transaction service provider system 302, issuer system 304, customer device 306, merchant system 308, and/or acquirer system 310 in FIG. 3, as an example. In some non-limiting embodiments or aspects, such systems or devices in FIG. 1 or FIG. 3 may include at least one device 400 and/or at least one component of device 400. The number and arrangement of components shown in FIG. 4 are provided as an example. In some non-limiting embodiments or aspects, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

As shown in FIG. 4, device 400 may include bus 402, processor 404, memory 406, storage component 408, input component 410, output component 412, and communication interface 414. Bus 402 may include a component that permits communication among the components of device 400. In some non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 4, storage component 408 may store information and/or software related to the operation and use of device 400. For example, storage component 408 may include a hard disk (e.g., a magnetic disk, an optical disk, a magneto-optic disk, a solid state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices. The term “programmed to” and/or “configured to,” as used herein, may refer to an arrangement of software, device(s), and/or hardware for performing and/or enabling one or more functions (e.g., actions, processes, steps of a process, and/or the like). For example, “a processor configured to” or “processor programmed to” may refer to a processor that executes software instructions (e.g., program code) that cause the processor to perform one or more functions.

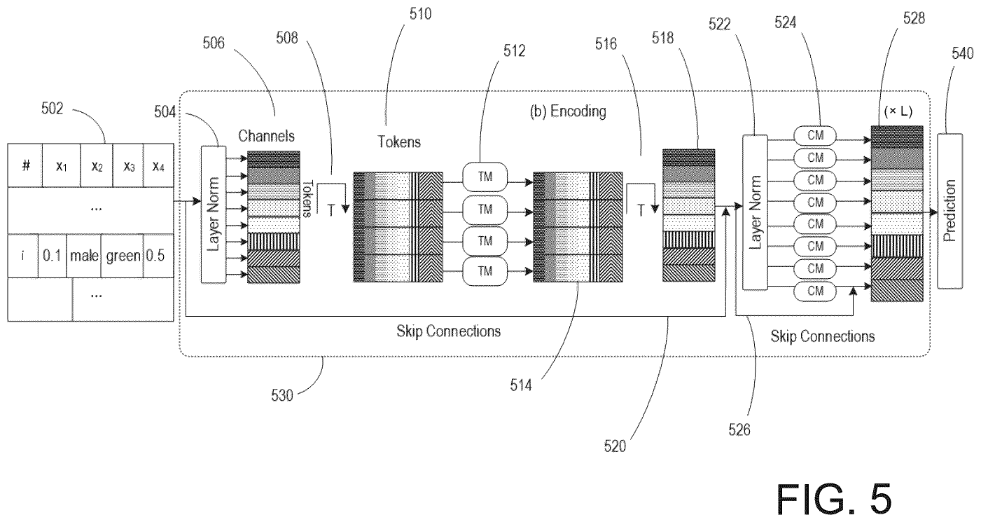

Referring now to FIG. 5, shown is a schematic diagram of an example implementation 500 of systems and methods for encoding feature interactions based on tabular data and machine learning according to some non-limiting embodiments or aspects. In some non-limiting embodiments or aspects, implementation 500 may be implemented by (e.g., performed by, part of, the same as, similar to, and/or the like) feature encoding system 102 and/or machine learning model 104 thereof.

In some non-limiting embodiments or aspects, dataset 502 may be received (e.g., by feature encoding system 102 and/or the like). For example, dataset 502 may be in a tabular format, including a plurality of rows (e.g., n rows) and a plurality of columns (e.g., m columns). In some non-limiting embodiments or aspects, each row of the n rows may represent a respective data instance of a plurality of data instances and/or each column of the m columns may represent a respective feature of a plurality of features. For example, the m features columns of a data instance x may be denoted as x=[x₁, . . . , xₘ], where xⱼ indexes the j-th column. For the purpose of illustration, as shown in FIG. 5, the four feature columns are x₁, x₂, x₃, x₄. For the i-th row, the respective data instance x⁽ⁱ⁾ may include a plurality of values x⁽ⁱ⁾=[x₁⁽ⁱ⁾, . . . , xₘ⁽ⁱ⁾], and each respective value may be associated with a respective feature of the m features. In some non-limiting embodiments or aspects, the plurality of data instances may include a plurality of payment transaction records. For the purpose of illustration, as shown in FIG. 5, x⁽ⁱ⁾ is instantiated with [0.1, Male, Green, 0.5].

In some non-limiting embodiments or aspects, each value of the plurality of values may be embedded (e.g., by feature encoding system 102 and/or the like) to generate a dense embedding matrix. In some non-limiting embodiments or aspects, each respective dense embedding matrix row of the dense embedding matrix may include a low-dimensional representation of the respective value. For example, each feature value in data instance x⁽ⁱ⁾=[x₁⁽ⁱ⁾, . . . , xₘ⁽ⁱ⁾] may be embedded to a dense and low-dimensional vector. In some non-limiting embodiments or aspects, a given feature value xⱼ⁽ⁱ⁾ can be either discrete or continuous in the tabular dataset 502. As such, for example, a discrete value may be encoded with an independent embedding, and/or a continuous value may be represented by scaling such a continuous value with a shared embedding. For the purpose of illustration, given the data instance x⁽ⁱ⁾, dense embedding matrix X_{dense}⁽ⁱ⁾ may be initialized as x_{dense}⁽ⁱ⁾∈ [symbol] ^{m×d}, where d is the dimension of the low-dimensional representation. For example, each row of X_{dense}⁽ⁱ⁾ may represent the low-dimensional representation of the respective value. In some non-limiting embodiments or aspects, each feature embedding in X₀⁽ⁱ⁾ may be mapped to initialize a corresponding node in a learned feature-interaction graph.

In some non-limiting embodiments or aspects, columns of tabular dataset 502 may be indexed (e.g., by feature encoding system 102 and/or the like) to generate a position embedding matrix. For example, each column of the plurality of columns may be indexed to generate a position embedding matrix including a plurality of position embedding vectors. In some non-limiting embodiments or aspects, each position embedding matrix row of the position embedding matrix may include a respective position embedding vector of the plurality of position embedding vectors associated with the respective column of the plurality of columns. For the purpose of illustration, given the m feature columns of data instance x=[x₁, . . . , xₘ], the position embedding matrix Xₚₒₛ may be denoted as Xₚₒₛ∈ [symbol] ^{m×d}, where each row may represent the spatial position of the corresponding column. In some non-limiting embodiments or aspects, the position embedding may be shared by all the data instances.

In some non-limiting embodiments or aspects, columns may be grouped (e.g., by feature encoding system 102 and/or the like) to generate a domain embedding matrix. For example, each column of the plurality of columns may be grouped based on at least one tree model to generate a domain embedding matrix including a plurality of domain embedding vectors. In some non-limiting embodiments or aspects, each column of the plurality of columns may be may grouped based on gradient-boosted decision trees (e.g., XGBoost and/or the like). For example, tree-based methods may enable discovery of non-linear dependencies among features, so gradient-boosted decision trees may group features into trees (e.g., correlated features within one tree could be regarded to be semantically similar, and the domain embedding may allow for learning such explicit feature combination). For the purpose of illustration, let T denote the number of trees and Tₜ={xⱼ₁, . . . , xⱼₘ} denote the feature set of the t-th tree. Considering the total of T trees, the domain embedding of feature column xⱼ is given by the following equation:

$${x}_{dom , j} = {\sum }_{t = 1}^{T} {x}_{dom , t} \cdot {{x}_{j} ∈ {T}_{t}}_{} ∈ {ℝ}^{1 \times d}$$

where x_{dom,t}∈ [symbol] ^{1×d} is the domain embedding shared by features within the t-th tree, and [symbol] ₓ_{ⱼ}_{∈T}_{ₜ} indicates whether feature j is in tree Tₜ. Considering all feature columns x=[x₁, . . . , xₘ] in tabular dataset 502, the domain embedding matrix may be given by X_{dom}≙[x_{dom,1}^{T}, . . . , x_{dom,m}^{T}]^{T}∈ [symbol] ^{m×d}, where T is the transpose operator. In some non-limiting embodiments or aspects, the domain embedding matrix may be shared by all the samples in the tabular data.

In some non-limiting embodiments or aspects, an input vector X may be generated (e.g., by feature encoding system 102 and/or the like). For example, an input vector X may be generated based on dataset 502, the position embedding matrix, and the domain embedding matrix. In some non-limiting embodiments or aspects, the input vector may be generated by concatenating at least one row of dataset 502, at least one position embedding vector of the position embedding matrix, and at least one domain embedding vector of the domain embedding matrix to produce the input vector. For the purpose of illustration, the input vector X for the i-th data instance may be generated based on the respective dense embedding matrix X_{dense}⁽ⁱ⁾, the position embedding matrix Xₚₒₛ, and the domain embedding matrix X_{dom}. For example, the input vector X for the i-th data instance may be generated based on concatenating these matrices as follows: =Concat(X_{dense}⁽ⁱ⁾, Xₚₒₛ, X_{dom})∈ [symbol] ^{m×3d}.

In some non-limiting embodiments or aspects, the input vector may be input (e.g., by feature encoding system 102 and/or the like) to at least one machine learning model (e.g., of machine learning models 104) generate a first output vector. For the purpose of illustration, as shown in FIG. 5, the input vector X may be input to layer normalization layer 504, which may generate a normalized input vector based on layer normalization. For the purpose of illustration, as shown in FIG. 5, matrix 506 may include the normalized input vectors for all data instances, and matrix 506 may include columns representing feature channels and rows representing data instance tokens (e.g., not to be confused with payment tokens). For example, the feature channels may be associated with the low-dimensional representation of the plurality of features, and each data instance token may be a representation of the respective data instance. In some non-limiting embodiments or aspects, the normalized input vectors may be transposed by transpose operation 508. For the purpose of illustration, as shown in FIG. 5, after transposing, transposed matrix 510 may include the transposed normalized input vectors, and, as such, transposed matrix 510 may include columns representing data instance token and rows representing feature channels. For the purpose of illustration, as shown in FIG. 5, each row of transposed matrix 510 may be input to a first MLP model (e.g., token mixing (TM) MLP model 512). In some non-limiting embodiments or aspects, TM MLP model 512 may include at least one fully connected layer and at least one non-linear activation function. For example, TM MLP model 512 may include a first fully connected layer represented by a first weight matrix W₁, an element-wise non-linear activation function σ (e.g., a Gaussian Error Linear Unit (GELU) activation function, a sigmoid activation function, and/or the like), and a second fully connected layer represented by a second weight matrix W₂. In some non-limiting embodiments or aspects, TM MLP model 512 may generate at least one first output vector (e.g., an output vector for each row of transposed matrix 510). For the purpose of illustration, as shown in FIG. 5, first output matrix 514 may include a row associated with the respective first output vector for each respective row of transposed matrix 510.

In some non-limiting embodiments or aspects, the first output vector(s) may be transposed (e.g., by feature encoding system 102 and/or the like) to generate a transposed vector. For the purpose of illustration, as shown in FIG. 5, first output matrix 514 (e.g., including rows associated with the first output vectors) may be transposed by transpose operation 516 to generate transposed first output matrix 518, and, as such, transposed first output matrix 518 may include columns representing feature channels and rows representing data instance tokens.

In some non-limiting embodiments or aspects, the transposed first output vector(s) may be combined with (e.g., added to, summed with, and/or the like) the input vector X (e.g., by feature encoding system 102 and/or the like) to generate an intermediate output U. For the purpose of illustration, as shown in FIG. 5, transposed first output matrix 518 (e.g., including the transposed first output vectors) may be added to the input vector X via skip connection 520 to generate an intermediate output U. For example, the intermediate output U may thus be represented by the following equation: U_{*,i}=X_{*,i}+W₂σ(W₁LayerNorm(X)_{*,i}), for i=1, . . . , C, where U is the matrix of intermediate outputs U, X is the matrix of input vectors X, and C is the number of channels.

In some non-limiting embodiments or aspects, the intermediate output(s) may be input (e.g., by feature encoding system 102 and/or the like) to at least one machine learning model (e.g., of machine learning models 104) generate a second output vector. For the purpose of illustration, as shown in FIG. 5, intermediate output(s) U (e.g., the matrix U of intermediate outputs U) may be input to layer normalization layer 522, which may generate at least one normalized intermediate output vector (e.g., a normalized intermediate output matrix LayerNorm(U)_{j,*}) based on layer normalization. For the purpose of illustration, as shown in FIG. 5, normalized intermediate output matrix LayerNorm(U)_{j,*} may include columns representing feature channels and rows representing data instance tokens. For the purpose of illustration, as shown in FIG. 5, each row of normalized intermediate output matrix LayerNorm(U)_{j,*} may be input to a second MLP model (e.g., channel mixing (CM) MLP model 524). In some non-limiting embodiments or aspects, CM MLP model 524 may include at least one fully connected layer and at least one non-linear activation function. For example, CM MLP model 524 may include a third fully connected layer represented by a third weight matrix W₃, an element-wise non-linear activation function σ (e.g., a Gaussian Error Linear Unit (GELU) activation function, a sigmoid activation function, and/or the like), and a fourth fully connected layer represented by a fourth weight matrix W₄. In some non-limiting embodiments or aspects, CM MLP model 524 may generate at least one second intermediate output vector (e.g., an output vector for each row of the matrix inputted thereto).

In some non-limiting embodiments or aspects, the second intermediate output vector(s) may be combined with (e.g., added to, summed with, and/or the like) the intermediate output(s) U (e.g., by feature encoding system 102 and/or the like). For the purpose of illustration, as shown in FIG. 5, the second intermediate output vector(s) may be added to the intermediate output(s) U via skip connection 526 to generate second output matrix 528 (e.g., feature embedding matrix Y), which may include the second output vectors. For example, second output matrix 528 (e.g., feature embedding matrix Y) may thus be represented by the following equation: Y_{j,*}=U_{j,*}+W₄σ(W₃LayerNorm(U)_{j,*}), for j=1, . . . , S, where S is the number of data instances.

In some non-limiting embodiments or aspects, all of 504-528 together may be referred to collectively as MLP mixer 530 (e.g., MLP mixer K). As such, given a data instance x⁽ⁱ⁾, a representation thereof may be determined (e.g., by feature encoding system 102 and/or the like) based on MLP mixer 530 by concatenating each feature embedding from Y₍ᵢ₎^{K}.

In some non-limiting embodiments or aspects, at least one prediction ŷ⁽ⁱ⁾ may be generated (e.g., by feature encoding system 102 and/or the like) by prediction model 540 (e.g., at least one classifier model and/or the like of machine learning models 104) based on the second output vectors (e.g., second output matrix 528 and/or the representation of data instance x⁽ⁱ⁾ determined based on concatenating each feature embedding from Y₍ᵢ₎^{K}).

In some non-limiting embodiments or aspects, the aforementioned machine learning models may be trained (e.g., by feature encoding system 102 and/or the like). For example, each data instance (and/or at least each data instance in a training set) may be associated with a label y⁽ⁱ⁾ (e.g., a true classification of the i-th data instance x⁽ⁱ⁾). A predicted classification ŷ⁽ⁱ⁾ may be generated (e.g., by feature encoding system 102 and/or the like) based on the i-th data instance x⁽ⁱ⁾, as described herein. A loss may be determined based on the label y⁽ⁱ⁾ and the predicted classification ŷ⁽ⁱ⁾. For the purpose of illustration, the loss for a classification task may be determined based on the following equation: Lₜₐₛₖ=y⁽ⁱ⁾log(ŷ⁽ⁱ⁾)+(1−y⁽ⁱ⁾)log(1−ŷ⁽ⁱ⁾). In some non-limiting embodiments or aspects, the parameters of the machine learning models (e.g., weights of the weight matrices and/or the like) may be adjusted (e.g. updated) based on the loss (e.g., based on stochastic gradient descent, back propagation, any combination thereof, and/or the like).

For the purpose of illustration, Table 1 shows area under the curve (AUC) of the disclosed subject matter compared to a transformer model and a graph neural network (GNN) model for two datasets:

TABLE 1

| | AUC (Dataset 1) | AUC (Dataset 2) |
|---|---|---|
| Transformer | 91.24 | — |
| GNN | — | 0.8084 |
| Disclosed Subject Matter | 91.16 | 0.8090 |

In Table 1, a dash (—) indicates the model failed. As shown in Table 1, the disclosed subject matter has comparable performance to a transformer model on the first dataset, and unlike the transformer model, the disclosed subject matter does not fail with respect to the large second dataset (e.g., due to the high complexity of a transformer, the transformer cannot be applied to large-scale second dataset). Additionally, the disclosed subject matter has improved performance compared to the GNN model for the second dataset. As such, the disclosed subject matter achieves comparable or improved performance compared to other models.

For the purpose of illustration, Table 2 shows time complexity of the disclosed subject matter compared to a transformer model and a GNN model for the second dataset:

TABLE 2

| | Time complexity (Dataset 2) |
|---|---|
| Transformer | — |
| GNN | 66.7 s/epoch |
| Disclosed Subject Matter | 33.2 s/epoch |

In Table 2, a dash (—) indicates the model failed. As shown in Table 2, the disclosed subject matter has much lower time complexity (e.g., is faster in terms of seconds per epoch) compared to the GNN for the large-scale second dataset, unlike the transformer model, the disclosed subject matter does not fail with respect to the large-scale second dataset. As such, the disclosed subject matter achieves improved speed and scalability compared to other models.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
receiving, with at least one processor, a dataset in a tabular format comprising a plurality of rows and a plurality of columns, wherein each row of the plurality of rows represents a respective data instance of a plurality of data instances, wherein each column of the plurality of columns represents a respective feature of a plurality of features, wherein each data instance of the plurality of data instances comprises a plurality of values comprising a respective value associated with each respective feature of the plurality of features;
indexing, with at least one processor, each column of the plurality of columns to generate a position embedding matrix comprising a plurality of position embedding vectors, wherein each position embedding matrix row of the position embedding matrix comprises a respective position embedding vector of the plurality of position embedding vectors associated with the respective column of the plurality of columns;
grouping, with at least one processor, each column of the plurality of columns based on at least one tree model to generate a domain embedding matrix comprising a plurality of domain embedding vectors;
generating, with at least one processor, an input vector based on the dataset, the position embedding matrix, and the domain embedding matrix;
inputting, with at least one processor, the input vector into a first multilayer perceptron (MLP) model to generate a first output vector;
transposing, with at least one processor, the first output vector to generate a transposed vector;
inputting, with at least one processor, the transposed vector into a second MLP model to generate a second output vector; and
inputting, with at least one processor, the second output vector into at least one classifier model to generate at least one prediction.

2. The computer-implemented method of claim 1, wherein the at least one prediction comprises at least one predicted label.

3. The computer-implemented method of claim 2, wherein the plurality of data instances comprises a plurality of payment transaction records, wherein the at least one predicted label indicates that a respective payment transaction record of the plurality of payment transaction records is predicted to be fraudulent.

4. The computer-implemented method of claim 1, wherein generating the input vector comprises:
concatenating at least one row of the dataset, at least one position embedding vector of the position embedding matrix, and at least one domain embedding vector of the domain embedding matrix to produce the input vector.

5. The computer-implemented method of claim 1, further comprising:
embedding, with at least one processor, each value of the plurality of values to generate a dense embedding matrix, each respective dense embedding matrix row of the dense embedding matrix comprising a low-dimensional representation of the respective value.

6. The computer-implemented method of claim 5, wherein generating the input vector comprises generating the input vector based on the dense embedding matrix, the position embedding matrix, and the domain embedding matrix.

7. The computer-implemented method of claim 6, wherein generating the input vector comprises:
concatenating at least one row of the dense embedding matrix, at least one position embedding vector of the position embedding matrix, and at least one domain embedding vector of the domain embedding matrix to produce the input vector.

8. The computer-implemented method of claim 5, wherein each value of the plurality of values comprises one of a discrete value or a continuous value, and wherein embedding each discrete value comprises encoding the discrete value with an independent embedding, and wherein embedding each continuous value comprises encoding the continuous value based on scaling the continuous value with a shared embedding.

9. The computer-implemented method of claim 1, further comprising:
modifying, with at least one processor, the input vector by replacing one or more values of the input vector to produce a modified input vector;
inputting, with at least one processor, the modified input vector into the first MLP model to generate a first modified output vector;
transposing, with at least one processor, the first modified output vector to generate a modified transposed vector;
inputting, with at least one processor, the modified transposed vector into the second MLP model to generate a second modified output vector; and
adjusting, with at least one processor, parameters of at least one of the first MLP model, the second MLP model, or any combination thereof based on at least one of the first modified output vector, the second modified output vector, the modified input vector, or any combination thereof.

10. The computer-implemented method of claim 1, further comprising:
normalizing, with at least one processor, the input vector based on layer normalization to generate a normalized input vector,
wherein inputting the input vector into the first MLP model comprises inputting the normalized input vector into the first MLP model.

11. The computer-implemented method of claim 1, wherein grouping each column based on at least one tree model to generate the domain embedding matrix comprises grouping each column based on gradient-boosted decision trees.

12. A system comprising:
at least one processor; and
at least one non-transitory computer-readable medium storing instructions that, when executed by the at least one processor, cause the at least one processor to:
receive a dataset in a tabular format comprising a plurality of rows and a plurality of columns, wherein each row of the plurality of rows represents a respective data instance of a plurality of data instances, wherein each column of the plurality of columns represents a respective feature of a plurality of features, wherein each data instance of the plurality of data instances comprises a plurality of values comprising a respective value associated with each respective feature of the plurality of features;
index each column of the plurality of columns to generate a position embedding matrix comprising a plurality of position embedding vectors, wherein each position embedding matrix row of the position embedding matrix comprises a respective position embedding vector of the plurality of position embedding vectors associated with the respective column of the plurality of columns;
group each column of the plurality of columns based on at least one tree model to generate a domain embedding matrix comprising a plurality of domain embedding vectors;
generate an input vector based on the dataset, the position embedding matrix, and the domain embedding matrix;
input the input vector into a first multilayer perceptron (MLP) model to generate a first output vector;
transpose the first output vector to generate a transposed vector;
input the transposed vector into a second MLP model to generate a second output vector; and
input the second output vector into at least one classifier model to generate at least one prediction.

13. The system of claim 12, wherein the at least one prediction comprises at least one predicted label, wherein the plurality of data instances comprises a plurality of payment transaction records, and wherein the at least one predicted label indicates that a respective payment transaction record of the plurality of payment transaction records is predicted to be fraudulent.

14. The system of claim 12, wherein generating the input vector comprises:
concatenating at least one row of the dataset, at least one position embedding vector of the position embedding matrix, and at least one domain embedding vector of the domain embedding matrix to produce the input vector.

15. The system of claim 12, wherein the instructions, when executed by the at least one processor, further cause the at least one processor to:
embed each value of the plurality of values to generate a dense embedding matrix, each respective dense embedding matrix row of the dense embedding matrix comprising a low-dimensional representation of the respective value,
wherein generating the input vector comprises generating the input vector based on the dense embedding matrix, the position embedding matrix, and the domain embedding matrix.

16. The system of claim 15, wherein generating the input vector comprises:
concatenating at least one row of the dense embedding matrix, at least one position embedding vector of the position embedding matrix, and at least one domain embedding vector of the domain embedding matrix to produce the input vector.

17. The system of claim 15, wherein each value of the plurality of values comprises one of a discrete value or a continuous value, and wherein embedding each discrete value comprises encoding the discrete value with an independent embedding, and wherein embedding each continuous value comprises encoding the continuous value based on scaling the continuous value with a shared embedding.

18. The system of claim 12, wherein the instructions, when executed by the at least one processor, further cause the at least one processor to:
modify the input vector by replacing one or more values of the input vector to produce a modified input vector;
input the modified input vector into the first MLP model to generate a first modified output vector;
transpose the first modified output vector to generate a modified transposed vector;
input the modified transposed vector into the second MLP model to generate a second modified output vector; and
adjust parameters of at least one of the first MLP model, the second MLP model, or any combination thereof based on at least one of the first modified output vector, the second modified output vector, the modified input vector, or any combination thereof.

19. The system of claim 12, wherein grouping each column based on at least one tree model to generate the domain embedding matrix comprises grouping each column based on gradient-boosted decision trees.

20. A computer program product comprising at least one non-transitory computer-readable medium including program instructions that, when executed by at least one processor, cause the at least one processor to:
receive a dataset in a tabular format comprising a plurality of rows and a plurality of columns, wherein each row of the plurality of rows represents a respective data instance of a plurality of data instances, wherein each column of the plurality of columns represents a respective feature of a plurality of features, wherein each data instance of the plurality of data instances comprises a plurality of values comprising a respective value associated with each respective feature of the plurality of features;
index each column of the plurality of columns to generate a position embedding matrix comprising a plurality of position embedding vectors, wherein each position embedding matrix row of the position embedding matrix comprises a respective position embedding vector of the plurality of position embedding vectors associated with the respective column of the plurality of columns;
group each column of the plurality of columns based on at least one tree model to generate a domain embedding matrix comprising a plurality of domain embedding vectors;
generate an input vector based on the dataset, the position embedding matrix, and the domain embedding matrix;
input the input vector into a first multilayer perceptron (MLP) model to generate a first output vector;
transpose the first output vector to generate a transposed vector;
input the transposed vector into a second MLP model to generate a second output vector; and
input the second output vector into at least one classifier model to generate at least one prediction.
